(19) United States
(12) Patent Application Publication
(10) Pub. No.: US 2006/0235929 A1
(43) Pub. Date: Oct. 19, 2006

(54) Electronic message notification

(75) Inventors: Edward Walter, Boerne, TX (US); Yolius Diroo, San Antonio, TX (US)

Correspondence Address: HANLEY, FLIGHT & ZIMMERMAN, LLC, 20 N. WACKER DRIVE, SUITE 4220, CHICAGO, IL, 60606, US

(73) Assignee: SBC KNOWLEDGE VENTURES, L.P., RENO, NV (US)

(21) Appl. No.: 11/105,187

(22) Filed: Apr. 13, 2005

(51) Int. Cl. G06F 15/16

(52) U.S. Cl. 709/206

(57) ABSTRACT

A technique that allows a recipient of an electronic message to be notified that the electronic message has been received for the recipient. A notification message containing an address of the recipient is used to notify an intelligent gateway in a communications network that an electronic message has been received for the recipient. The intelligent gateway uses the notification message to identify a telephone number associated with the recipient. The intelligent gateway uses the identified telephone number to call the recipient and rings the recipient's telephone using a distinctive ring to notify the recipient that an electronic message has been received for the recipient.

### TECHNICAL FIELD

This invention relates to electronic messaging and in particular to issuing a notification that an electronic message has been received.

### BACKGROUND OF THE INVENTION

With the advent of the Internet, electronic messaging, such as electronic mail (e-mail), has become a widely used technique for disseminating information from one user to another. In fact, many users prefer electronic messaging to convey information because of the rapid delivery rather than other techniques, such as conventional posted letters which may take many days to deliver.

In a conventional e-mail system, a sender composes the body text of the e-mail message and specifies an address of the message's recipient using an e-mail client at the sender's computer system. The sender then directs the client to send the message. The e-mail client connects to the sender's e-mail server and transfers the message to the server. The server forwards the message via a data network (e.g., the Internet) to the recipient's e-mail server which acquires the message and forwards it to the recipient's e-mail client at the recipient's computer system. The recipient's e-mail client may then notify the recipient that the e-mail message has been received by e.g., sounding a tone or displaying a message on the recipient's computer system. The recipient then directs the e-mail client to display the message.

### SUMMARY OF THE INVENTION

One problem with the above described system is that if the recipient is not present at the recipient's computer system when an electronic message (e.g., e-mail) is received, the recipient may not get the notification of the received electronic message. This may provide an inconvenience for recipients who need to be notified of electronic messages they may be expecting, however, they may not be presently located at their computer system.

The present invention overcomes the above and other shortcomings by incorporating a technique that allows a recipient of electronic messages to be notified of the messages without requiring the recipient to be present at a computer system that normally receives notification of the messages.

Illustratively, an e-mail server receives an e-mail message destined for a recipient, generates a notification message containing information from the e-mail message and forwards it to an intelligent gateway associated with the recipient. The intelligent gateway receives the notification message and identifies a telephone number associated with the recipient. The intelligent gateway then notifies the recipient of the e-mail message by ringing the recipient's telephone using a distinctive ring. The recipient may then answer the telephone and receive additional information about the e-mail message, including, for example, audio information from the intelligent gateway that indicates that the message is from a particular user, the subject matter of the message and the time and date the message was sent.

Advantageously, the inventive technique is an improvement over prior techniques in that a recipient of an electronic message need not be present at e.g., their computer system in order to be notified of an electronic message for the recipient.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a high-level schematic block diagram of an exemplary communications network that may be used with the present invention.

FIG. 2 is a high-level schematic block diagram of another exemplary communications network that may be used with the present invention.

FIG. 3 is a high level partial schematic block diagram of an intelligent gateway that may be used with the present invention.

FIG. 4 is a schematic block diagram of a look-up database that may be used with the present invention.

FIG. 5 is a schematic block diagram of a notification message that may be used with the present invention.

FIG. 6 is a flow chart of a sequence of steps that may be used to process a notification message in accordance with an aspect of the present invention.

FIG. 7 is a flow chart of a sequence of steps that may be used to generate an e-mail message, transfer the e-mail message to a recipient and notify the recipient of the arrival of the e-mail message in accordance with an aspect of the present invention.

### DESCRIPTION OF AN ILLUSTRATED EMBODIMENT OF THE INVENTION

A description of preferred embodiments of the invention follows.

The following described embodiments of the invention describe the invention as used with electronic mail (e-mail). It should be noted, however, that other electronic messaging techniques may take advantage of the present invention.

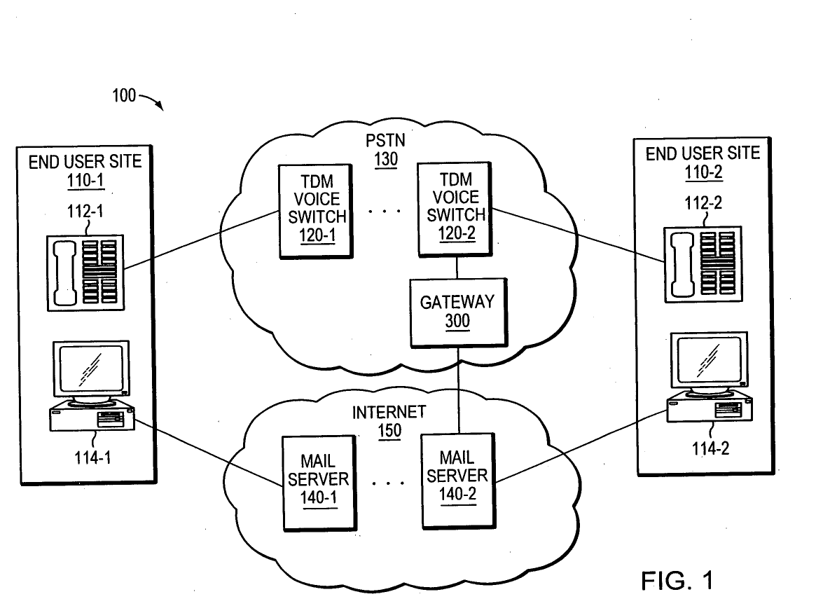

FIG. 1 is a high-level schematic block diagram of an exemplary communications network that may be used with the present invention. Network 100 comprises end user sites 110-1, 110-2, a public switched telephone network (PSTN) 130 and an Internet network 150. Each end user site 110-1, 110-2 further contains a communication device 112 (e.g., a telephone) and a computer node 114.

The Internet 150 illustratively comprises one or more e-mail servers 140 that are used to process e-mail transferred between the end nodes 114 via the Internet 150. The PSTN 130 further comprises one or more time-division multiplexing (TDM) voice switches 120-1, 120-2 and an intelligent gateway 300. The TDM voice switches 120-1, 120-2 are conventional voice switches used to transfer standard TDM signals generated from the communication units 112 through the PSTN 130. The intelligent gateway 300, as will be described further below, is configured to notify recipients of the arrival of an electronic message in accordance with the present invention. The communication units 112-1, 112-2 are illustratively telephone units capable distinctively ringing under the direction of voice switches 120-1, 120-2. Illustratively, this ring is a particular ring sequence that is generated by the voice switches 120-1, 120-2. Alternatively, the telephone units may be specially configured to generate specific ring tones as directed by e.g., the voice switches 120. Note that the communication units 112-1, 112-2 may be conventional telephone units, wireless telephone units and so on. The end nodes 114-1, 114-2 are illustratively conventional personal computers (PCs) which are configured to generate and receive e-mail messages from the mail servers 140-1, 140-2.

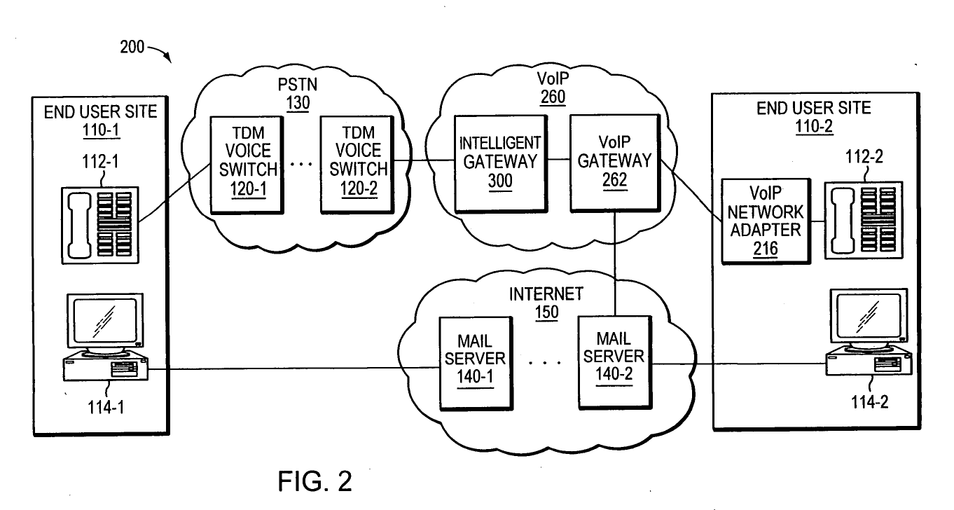

FIG. 2 is a high-level schematic block diagram of another exemplary communications network that may be used with the present invention. Network 200 comprises end user sites 110-1, 110-2, a PSTN 130, Internet 150 and a VoIP network 260. End user sites 110-1, 110-2 comprise communication units 112-1, 112-2 and end nodes 114-1, 114-2. End user site 110-2 further comprises a VoIP network adapter 216 that is configured to interface communication unit 112-2 with the VoIP network 260. An example of an adapter that may be used with the present invention is the Linksys PAP2 adapter available from Linksys, a division of Cisco Systems Incorporated, Irvine, Calif. It should be noted that, alternatively, functions performed by the VoIP network adapter 216 may be integrated in communication unit 112-2. End nodes 114-1, 114-2 are illustratively conventional PCs, as described above. Communication units 112-1, 112-2 are illustratively telephone units, such as conventional telephone units, wireless telephone units and the like, that are capable of distinctively ringing. Additionally, the communication units 112-1, 112-2 may contain logic that enables the units to display text messages generated by, e.g., the intelligent gateway 300.

The PSTN 130 comprises one or more conventional TDM voice switches 126-1, 120-2, as described above. Likewise, the Internet 150 comprises one or more e-mail servers 140, as described above. The VoIP network 260 comprises an intelligent gateway 300 and a VoIP gateway 262. The VoIP gateway 262 is a conventional VoIP gateway that is configured to interface the VoIP network adapter 216 with the VoIP network 260. The intelligent gateway 300 is an intelligent gateway device as described above.

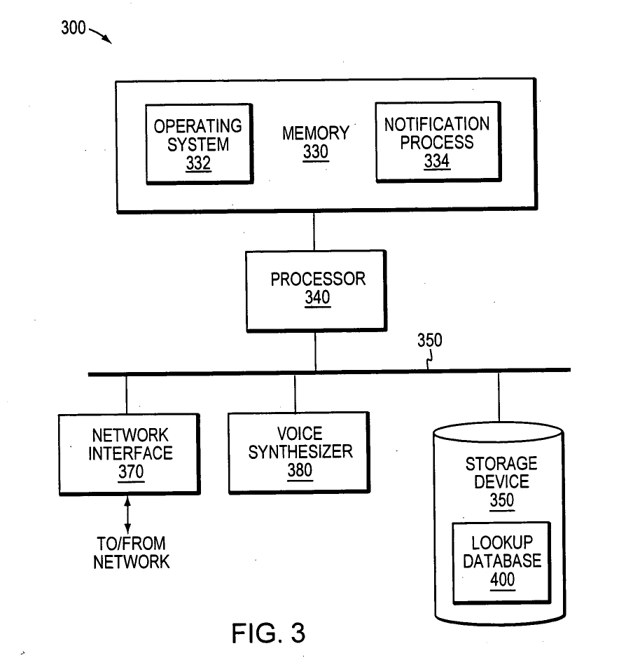

FIG. 3 is a partial schematic block diagram of an intelligent gateway 300 that may be used with the present invention. The intelligent gateway 300 illustratively comprises a memory 330, and a processor 340 coupled to a storage device 350, a voice synthesizer 380 and a network interface 370 via input/output (I/O) bus 350. It should be noted that the intelligent gateway 300 may contain other I/O devices, such as a display unit, a keyboard unit and so on.

The processor 340 is a conventional processor capable of executing computer executable instructions and manipulating data structures contained in memory 330. The voice synthesizer 380 is a conventional voice synthesizer unit configured to generate signals that represent audible voice signals from data provided by processor 340. The network interface 370 is a conventional network interface that enables data to be transferred between the intelligent gateway 300 and the networks 100, 200. The memory 330 is a computer readable storage medium organized as a random access memory (RAM) that is implemented using various RAM devices such as dynamic random access memory (DRAM) devices. The memory 330 is configured to hold various executable instructions and data structures including computer executable instructions and data structures that implement aspects of the present invention. It should be noted that other computer readable storage mediums, such as disk units and flash memory, may be configured to hold computer readable instructions and data that implement aspects of the present invention. In addition, it should be noted that various electromagnetic signals may be encoded to carry instructions and data that implement aspects of the present invention over, for example, a data network.

The memory 330 contains an operating system 332 and a notification process 334. It should be noted that memory 330 may contain other software processes as well as data structures that are accessed by the processes including process 334. The operating system is a conventional operating system that provides various functions that support execution of the notification process 334.

Storage device 350 is a conventional storage device, such as a disk unit, that comprises a lookup database 400 which is configured to provide, inter alia, information about recipients of e-mail messages.

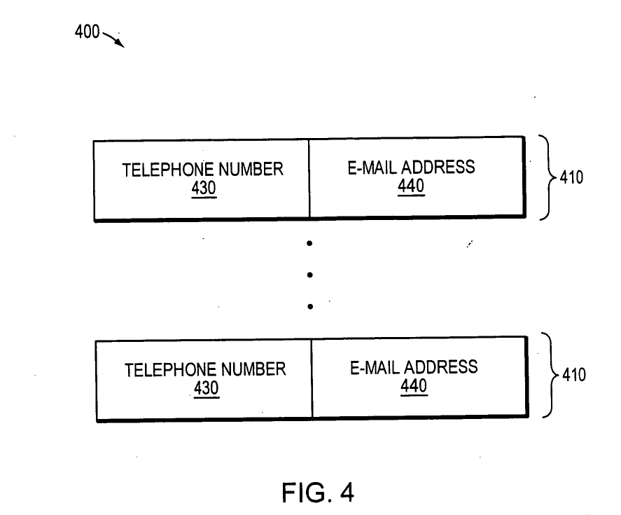

FIG. 4 is a schematic block diagram of a lookup database 400 that may be used with the present invention. Database 400 is illustratively configured as a database table comprising one or more database entries 410 wherein each entry 410 is associated with a recipient and comprises a telephone number 430 and an e-mail address 440 of the recipient. The telephone number field 430 holds a value that represents a telephone number associated with the recipient. The e-mail address field 440 holds a value that represents an e-mail address associated with the recipient.

In accordance with an aspect of the present invention, in response to receiving an e-mail message for a particular recipient, the recipient's e-mail server 140 generates a notification message that contains information about the e-mail message and forwards the notification message to the intelligent gateway 300 to inform the gateway 300 that an e-mail message has been received.

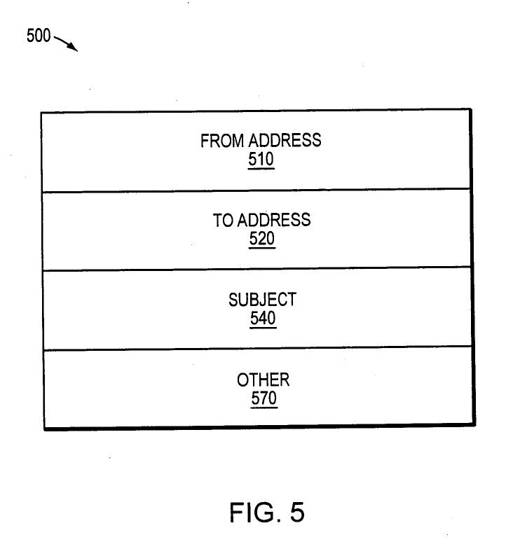

FIG. 5 is a schematic block diagram of a notification message 500 that may be used with the present invention. Notification message 500 comprises a “from address” field 510, a “to address” field 520, a subject field 540 and an “other” field 570. The “from address” field 510 illustratively holds a value that represents an address (e.g., e-mail address) of the sender of an e-mail message. The “to address” field 520 illustratively holds a value that represents an address (e.g., e-mail address) of the e-mail message's recipient. The subject field 540 illustratively holds a value that represents a subject associated with the e-mail message. The “other” field 570 illustratively holds a value that represents other information associated with the e-mail message. For example, this field 570 may hold a value that represents a time/date when the message was sent by the sender.

Illustratively, the recipient's e-mail server generates a notification message 500 by placing: an address of the sender contained in the e-mail message in the “from address” field 510, an address of the recipient contained in the e-mail message in the “to address” field 520, a subject contained in the e-mail message in the subject field 540 and other information associated with the e-mail message in the “other” field 570.

In accordance with an aspect of the present invention, after an intelligent gateway 300 receives a notification message from a recipient's e-mail server 140, the intelligent gateway 300 further processes the notification message and notifies the recipient that the e-mail message has been received by the recipient's e-mail server.

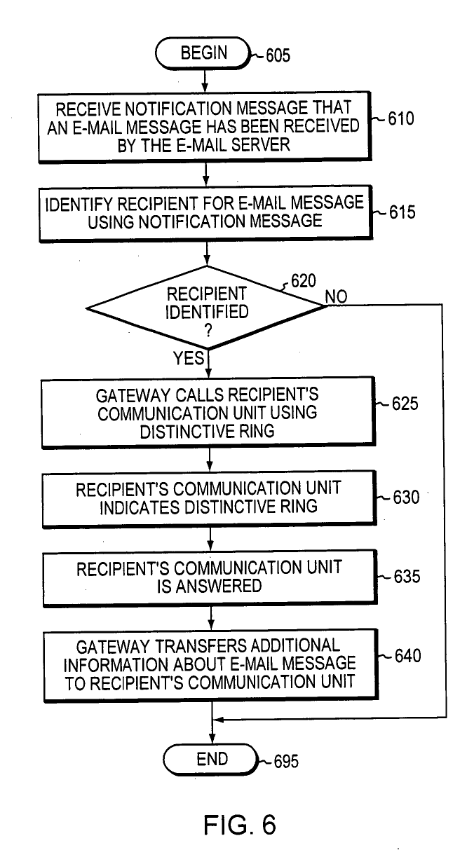

FIG. 6 is a flow chart of a sequence of steps that may be used to process a notification message 500 in accordance with an aspect of the present invention. The sequence begins at step 605 and proceeds to step 610 where the notification message 500 associated with the e-mail message is received illustratively from the recipient's e-mail server 140 by the recipient's intelligent gateway 300. At step 615, the notification message 500 is used to determine the recipient of the e-mail message. Illustratively, notification process 334 examines the notification message 500 and uses the content of the “to address” field 520 to locate an entry 410 in lookup database 400 whose e-mail address field 440 contains a value that matches the content of the “to address” field 520 in the notification message 500. If a matching entry 410 is found the recipient is illustratively considered identified. Otherwise, the recipient is not considered identified.

Next, at step 620, a check is performed to determine if the recipient has been identified. If not, the sequence proceeds to step 695. Otherwise, the sequence proceeds to step 625 where illustratively the recipient's intelligent gateway 300 notifies the recipient of the received e-mail message by placing a call to the recipient's communication unit 112 and causing the recipient's communication unit 112 to distinctively ring (step 630). Further, illustratively, the distinctive ring may be a particular distinctive ring sequence, a distinctive ring tone, a visual indicator on the communication unit or the like. The recipient's communication unit is answered (step 635) and additional information about the electronic message is transferred to the recipient's communication unit 112 (step 640). Illustratively, the information contained in the notification message is converted to voice information by the intelligent gateway's voice synthesizer 380 and transferred to the communication unit 112. Alternatively, the additional information may be transferred to the communication unit 112 in a form that enables the additional information to be displayed at a display unit associated with the communication unit 112. The sequence ends at step 695.

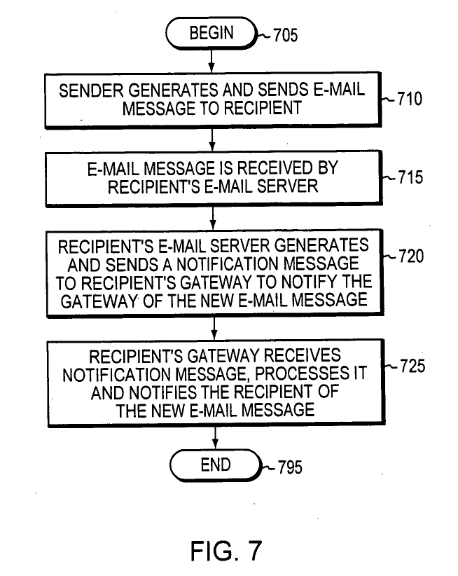

FIG. 7 is a flow chart of a sequence of steps that may be used to send an e-mail message from a sender to a recipient and notify the recipient of the receipt of the electronic message in accordance with an aspect of the present invention.

The sequence begins at step 705 and proceeds to step 710 where the sender generates and sends an e-mail message to the recipient. At step 715, the recipient's e-mail server 140 receives the e-mail message. In response to receiving the message, the recipient's e-mail server 140 illustratively generates and sends a notification message 500 to the recipient's intelligent gateway 300 (step 720), as described above. The recipient's intelligent gateway 300 receives the notification message 500 and notifies the recipient, as described above (step 725). The sequence ends at step 795.

For example, referring to FIGS. 1 and 7, assume a sender at end user site 110-1 generates and sends an e-mail message at node 114-1 to a recipient at end user site 110-2 (step 710). Further assume that the recipient uses end node 114-2 to receive his e-mail messages. The e-mail message is forwarded through network 150, as described above, and is eventually received by the recipient's e-mail server 140-2 (step 715). In response to the e-mail message, e-mail server 140-2 generates a notification message 500 and sends it to the intelligent gateway 300 (step 720), as described above.

Referring now to FIG. 6, the notification message 500 is received by the intelligent gateway 300 (step 610) and is forwarded to the notification process 334. The notification process 334 processes the message 500 including using the content of the “to address” field 520 to identify a recipient, as described above (step 615). Assuming a recipient is identified (step 620) the notification process 334 directs the intelligent gateway 300 to call the telephone number 430 associated with the recipient (step 625). Assume the telephone number is the telephone number of communication unit 112-2. Communication unit 112-2 rings with a distinctive ring to indicate that an e-mail message has been received for the recipient by the recipient's e-mail server 140-2 (step 630). Assuming the recipient answers the telephone call (step 635), the intelligent gateway 300 converts information contained in the notification message, such an address of the sender, the subject of the message and so on, illustratively to voice signals which are sent to the communication unit 112-2 and played for the user (step 640).

Referring now to FIGS. 2 and 7, assume a sender at site 110-1 generates sends and sends an e-mail message to a recipient at site 110-2 (step 710). Further assume that the recipient uses end node 114-2 to receive his e-mail messages. The e-mail message is forwarded from node 114-1 to mail server 140-1 is eventually received by the recipient's e-mail server 140-2 (step 715). In response to receiving the e-mail message, e-mail server 140-2 generates a notification message 500, as described above, and sends it to the intelligent gateway 300 (step 720). The intelligent gateway 300 receives the notification message and in response, notifies the recipient of the new message (step 725), as described above.

While this invention has been particularly shown and described with references to preferred embodiments thereof, it will be understood by those skilled in the art that various changes in form and details may be made therein without departing from the scope of the invention encompassed by the appended claims.

What is claimed is:

1. A computer readable medium comprising computer executable instructions for:
receiving a notification message that the electronic message has been received; and
notifying the recipient of the electronic message using a distinctive ring.

2. A computer readable medium as defined in claim 1 wherein the electronic message is an electronic mail (e-mail) message.

3. A computer readable medium as defined in claim 1 wherein the distinctive ring is a distinctive ring sequence.

4. A computer readable medium as defined in claim 1 wherein the distinctive ring is a distinctive ring tone.

5. A computer readable medium as defined in claim 1 wherein the distinctive ring is a visual indicator on a communication unit associated with the recipient.

6. A computer readable medium as defined in claim 1 further comprising computer executable instructions for:
calling a communication unit associated with the recipient using the distinctive ring.

7. A computer readable medium as defined in claim 6 wherein the communication unit is a telephone handset.

8. A computer readable medium as defined in claim 6 wherein the communication unit is a wireless telephone handset.

9. A computer readable medium as defined in claim 6 wherein the communication unit is a soft phone.

10. A computer readable medium as defined in claim 1 further comprising computer executable instructions for:
transferring additional information associated with the electronic message to a communication unit associated with the recipient.

11. A computer readable medium as defined in claim 10 wherein the additional information includes an address associated with a sender of the electronic message.

12. A computer readable medium as defined in claim 10 wherein the additional information includes a subject associated with the electronic message.

13. A computer readable medium as defined in claim 10 wherein the additional information is transmitted to the communication unit as voice data.

14. A computer readable medium as defined in claim 10 wherein the additional information is transmitted to a display unit associated with the communication unit.

15. A method for notifying a recipient of receipt of an electronic message for the recipient, the method comprising:
receiving the electronic message; and
notifying the recipient of the electronic message using a distinctive ring.

16. A method as defined in claim 15 wherein the electronic message is an electronic mail (e-mail) message.

17. A method as defined in claim 15 wherein the distinctive ring is a distinctive ring sequence.

18. A method as defined in claim 15 wherein the distinctive ring is a distinctive ring tone.

19. A method as defined in claim 15 wherein the distinctive ring is a visual indicator on a communication unit associated with the recipient.

20. A method as defined in claim 15 further comprising:
calling a communication unit associated with the recipient using the distinctive ring.

21. A method as defined in claim 15 further comprising:
transmitting additional information associated with the electronic message to a communication unit associated with the recipient.

22. A method as defined in claim 21 wherein the additional information is transmitted to the communication unit as voice data.

23. An intelligent gateway for notifying a recipient of receipt of an electronic message for the recipient, the intelligent gateway comprising:
a memory; and
a processor coupled to the memory and configured to:
(a) receive a notification message that the electronic message has been received, and
(b) notify the recipient of the electronic message using a distinctive ring.

24. An intelligent gateway as defined in claim 23 wherein the notification message contains an address of the recipient.

25. An intelligent gateway as defined in claim 24, further comprising:
a lookup database having one or more records wherein each record has a telephone number associated with a recipient, and
wherein the processor is further configured to:
(a) identify a telephone number associated with the recipient using the lookup database, and
(b) notify the recipient of the electronic message using a distinctive ring by calling the recipient's telephone number and ringing a telephone associated with the recipient's telephone number with the distinctive ring.

26. An intelligent gateway as defined in claim 23 wherein the processor is further configured to transmit additional information associated with the electronic message to the recipient.

27. An apparatus for notifying a recipient of receipt of an electronic message for the recipient, the apparatus comprising:
means for receiving the electronic message; and
means for notifying the recipient of the electronic message using a distinctive ring.

28. An apparatus as defined in claim 27 further comprising:
means for transmitting additional information associated with the electronic message to the recipient.

29. A system for notifying a recipient of receipt of an electronic message for the recipient, the system comprising:
means for receiving the electronic message; and
means for notifying the recipient of the electronic message using a distinctive ring.

30. Electromagnetic signals traveling on a data network, the electromagnetic signals carrying instructions for execution on a processor for:
receiving an electronic message; and
notifying a recipient of the electronic message using a distinctive ring.

31. Electromagnetic signals as defined in claim 30 further carrying instructions for execution on a processor for:
transmitting additional information associated with the electronic message to the recipient.
